(19) United States
(12) Patent Application Publication
(10) Pub. No.: US 2017/0368682 A1
(43) Pub. Date: Dec. 28, 2017

(54) NEURAL NETWORK APPARATUS AND CONTROL METHOD OF NEURAL NETWORK APPARATUS

(71) Applicant: FUJITSU LIMITED, Kawasaki-shi (JP)

(72) Inventors: Takumi Danjo, Kawasaki (JP); Hirotaka TAMURA, Yokohama (JP); Sanroku Tsukamoto, Setagaya (JP)

(73) Assignee: FUJITSU LIMITED, Kawasaki-shi (JP)

(21) Appl. No.: 15/606,220

(22) Filed: May 26, 2017

(30) Foreign Application Priority Data
Jun. 27, 2016 (JP) 2016-126941

(51) Int. Cl. B25J 9/16; G06N 3/04; G06N 3/063; G06N 3/08

(52) U.S. Cl. CPC B25J 9/161; G06N 3/082; G06N 3/049; G06N 3/063

(57) ABSTRACT

A neural network apparatus includes: a plurality of neuron units each including: an adder that performs addition processing and one or more digital analog converters that perform digital-analog conversion processing, relating to weighted inputs; and a delta-sigma analog digital converter that converts an analog signal indicating an added value obtained by adding all of the weighted inputs obtained from the adder and the one or more digital analog converters, into a pulse signal according to an amplitude, and outputs the pulse signal; a plurality of arithmetic units each of which multiplies the pulse signal outputted from one neuron unit by a weighted value, and outputs a result to another neuron unit; and an oscillator that is capable of changing a frequency of a clock signal to be outputted and supplies the clock signal to the neuron unit and the arithmetic unit according to control from a control unit.

### CROSS-REFERENCE TO RELATED APPLICATION

This application is based upon and claims the benefit of priority of the prior Japanese Patent Application No. 2016-126941, filed on Jun. 27, 2016, the entire contents of which are incorporated herein by reference.

### FIELD

The embodiments discussed herein are directed to a neural network apparatus, and a control method of the neural network apparatus.

### BACKGROUND

A brain of a creature has many neurons, and each neuron acts to receive a signal inputted from other many neurons and to output signals to other many neurons. Such a mechanism of the brain tried to be realized by a computer is a neural network, and is an engineering model that mimics the behavior of the nerve cell network of the creature. There are various neural networks including, for example, a hierarchical neural network that is often used for object recognition and an undirectional graph (bidirectional graph) neural network that is used for optimization problem and image restoration.

As one example of the hierarchical neural network, perceptron composed of two layers such as an input layer and an output layer is illustrated in FIG. 21A. The output layer uses a value calculated from a value obtained by adding signals x weighted with weights w from the input layer and a threshold value (bias) 8 that the output layer itself has, as an input variable of an output function f( ) and outputs a result. In the perceptron, the output function is a step function and, for example, outputs 1 when the input variable is 0 or more, and outputs 0 when the input variable is less than 0. A multilayer perceptron made by stacking perceptron in a plurality of stages is illustrated in FIG. 21B. The multilayer perceptron includes one or more hidden layers (intermediate layers) in addition to the input layer and the output layer.

FIG. 22 illustrates an example of the undirectional graph neural network. The undirectional graph neural network is a neural network in which connected nodes affect one another. In the undirectional graph neural network, each node has a value 1 or −1 as an input/output value x and has a bias b, and a weight w is provided between the nodes. Note that the weight w from one node to the other node which are connected is equal to the weight w from the other node to the one node. For example, a weight w₁₂ from a first node to a second node is the same as a weight w₂₁ from the second node to the first node.

Defining energy E(x) of the undirectional graph neural network as an expression illustrated in FIG. 22, the undirectional graph neural network operates to bring the energy E(x) to a minimum value while varying the value x, when the weight w and the bias b are applied thereto. A neural network that shifts to a direction where the energy E(x) necessarily decreases, namely, performs definite state change, is a hopfield network (HNN). A neural network that shifts also to a direction where the energy E(x) increases, namely, performs stochastic state change, is a Boltzmann machine (BM).

When the neural network is mounted as software, a large quantity of parallel operation is operated, resulting in slow processing. Hence, there is a proposed technique of improving the processing speed of the neural network by mounting the neural network by a circuit being hardware (refer to, for example, Patent Document 1 and Non-Patent Documents 1, 2).

Examples of mounting the neural network by the circuit will be explained referring to FIG. 23A to FIG. 23C. In the perceptron illustrated in FIG. 23A, a neuron element (artificial neuron) obtains a total sum of inputs x weighted with weights w and compares the total sum with a bias θ of the neuron element. The neuron element outputs 1 as an output y when the total sum of the weighted inputs is equal to or more than the bias θ, and outputs 0 as the output y when it is less than the bias θ. Accordingly, the neuron element can be realized by combining an adder and a determiner (comparator).

FIG. 23B and FIG. 23C are diagrams illustrating circuit mounting examples of the neural network. FIG. 23B illustrates a circuit example of obtaining the total sum of the weighted inputs by a digital adder. In FIG. 23B, 2310 denotes a neuron unit and 2320 denotes a digital arithmetic unit that applies a weight. The neuron unit 2310 includes a digital adder 2311, a digital analog converter (DAC) 2312, and a delta-sigma analog digital converter (ΔΣ-ADC) 2313.

The digital adder 2311 adds weighted input signals w₁x₁, w₂x₂, w₃x₃, . . . , wₙxₙ inputted into the neuron unit 2310 to obtain a total sum. The DA converter 2312 outputs an analog signal obtained by digital-analog converting the total sum of the weighted inputs outputted from the digital adder 2311. The -AD converter 2313 analog-digital converts the analog signal outputted from the DA converter 2312 into a pulse signal as a digital signal according to the amplitude of the analog signal, and outputs the pulse signal. The digital arithmetic unit 2320 multiplies a pulse signal y outputted from the neuron unit 2310 (-AD converter 2313) by a weight w, and outputs a weighted signal wy.

FIG. 23C illustrates a circuit example that obtains the total sum of the weighted inputs by an analog adder. In FIG. 23C, 2330 denotes a neuron unit and 2340 denotes a digital arithmetic unit that applies a weight. The neuron unit 2330 includes DA converters (DACs) 2331, an analog adder 2332, and a ΔΣ-AD converter (ΔΣ-ADC) 2333.

The DA converters 2331 output analog signals made by digital-analog converting weighted input signals w₁x₁, w₂x₂, w₃x₃, . . . , wₙxₙ inputted into the neuron unit 2330 respectively. The analog adder 2332 adds the analog signals outputted from the DA converters 2331 to obtain the total sum. The ΔΣ-AD converter 2333 analog-digital converts the analog signal outputted from the analog adder 2332 into a pulse signal as a digital signal according to the amplitude of the analog signal, and outputs the pulse signal. The digital arithmetic unit 2340 multiplies a pulse signal y outputted from the neuron unit 2330 (-AD converter 2333) by a weight w, and outputs a weighted signal wy.

When the ΔΣ-AD converter is used as a determiner as in the circuit configurations illustrated in FIG. 23B and FIG. 23C, quantization noise generated during the AD conversion is low on a low frequency side and high on a high frequency side by noise shaping. Since the ΔΣ-AD converter has high pass characteristics as explained above, increasing the sampling frequency with respect to the frequency of the input signal makes it possible to decrease the quantization noise existing in a frequency band of the input signal by noise shaping so as to increase a signal to noise ratio (SNR), thereby improving accuracy.

For example, where the frequency band of the input signal is BW and the sampling frequency is fs in the ΔΣ-AD converter, an over sampling rate (OSR) is defined to be (fs/2BW). Where the number of valid bits of resolution of the ΔΣ-AD converter is N, the SNR in the bandwidth of the input signal in a primary ΔΣ-AD converter is expressed by about (6.02 N+1.76-5.17+30 log (OSR)), and the SNR in the bandwidth of the input signal in a secondary ΔΣ-AD converter is expressed by about (6.02 N+1.76-12.9+50 log (OSR)). Accordingly, when the over sampling rate decuples, namely, the sampling frequency fs decuples, the SNR increases by about 30 dB in the primary ΔΣ-AD converter and the SNR increases by about 50 dB in the secondary ΔΣ-AD converter. As explained above, with an increase in the sampling frequency, the quantization noise existing in the frequency band of the input signal can be decreased.
[Patent Document 1] Japanese Laid-open Patent Publication No. 2-27493
[Non-Patent Document 1] B. E. Boser et al., “An Analog Neural Network Processor with Programmable Topology,” IEEE J. Solid-State Circuits, vol. 26, no. 12, pp. 2017-2025, 1991.
[Non-Patent Document 2] C. R. Schneider and H. C. Card, “Analog CMOS Deterministic Boltzmann Circuits,” IEEE J. Solid-State Circuits, vol. 28, no. 8, pp. 907-914, 1993.

FIG. 24 is a diagram illustrating a configuration example of a conventional neural network apparatus using the circuit illustrated in FIG. 23B. In the neural network apparatus illustrated in FIG. 24, a plurality of neuron units 2310, each including a digital adder 2311, a DA converter 2312, and a ΔΣ-AD converter 2313, are connected via digital arithmetic units 2320 to constitute a hierarchical neural network. For example, a neuron unit 2310-(n−1) in an (n−1)-th layer and a neuron unit 2310-n in an n-th layer are connected via a digital arithmetic unit 2320-(n−1). An output yₙ₋₁ from the neuron unit 2310-(n−1) in the (n−1)-th layer is weighted by the digital arithmetic unit 2320-(n−1) and inputted to the neuron unit 2310-n in the n-th layer. Each of the neuron units 2310 and digital arithmetic units 2320 is supplied with a clock signal CK having a fixed frequency outputted from an oscillator 2350 as an operating clock.

In the conventional neural network apparatus, a clock signal having a fixed frequency is supplied as an operating clock to the neuron unit and the digital arithmetic unit, so that all of circuits such as the neuron unit and the digital arithmetic unit operate with the same constant frequency regardless of the layer and the operation time. This is the same also in the neural network apparatus of the undirectional graph neural network. Therefore, the operating frequency of the neural network apparatus is restricted by the circuit operating with the highest frequency, and all of the circuits operate with the operating frequency of a layer where the calculated amount is large and which is required to have high accuracy (SNR), resulting in increased power consumption.

### SUMMARY

An aspect of the neural network apparatus includes: a plurality of neuron units each including: an adder that performs addition processing and one or more digital analog converters that perform digital-analog conversion processing, relating to a plurality of weighted inputs; and a delta-sigma analog digital converter that converts an analog signal indicating an added value obtained by adding all of the plurality of weighted inputs obtained from the adder and the one or more digital analog converters, into a pulse signal according to an amplitude, and outputs the pulse signal; a plurality of arithmetic units each of which multiplies the pulse signal outputted from one neuron unit by a weighted value, and outputs a result to another neuron unit; and an oscillator that is capable of changing a frequency of a clock signal to be outputted and supplies the clock signal to the neuron unit and the arithmetic unit according to control from a control unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a neural network apparatus in a first embodiment;

FIG. 2 is a diagram illustrating a configuration example of a ΔΣ-AD converter in the first embodiment;

FIG. 3 is a diagram illustrating a configuration example of an analog integrator in the first embodiment;

FIG. 4 is a diagram illustrating a configuration example of a comparator in the first embodiment;

FIG. 5A is a diagram illustrating a configuration example of a variable frequency oscillator in the first embodiment;

FIG. 5B is a diagram illustrating a configuration example of a DA converter of the variable frequency oscillator in the first embodiment;

FIG. 5C is a diagram illustrating a configuration example of a voltage control oscillator of the variable frequency oscillator in the first embodiment;

FIG. 6 is a diagram illustrating an configuration example of the neural network apparatus in the first embodiment;

FIG. 7 is a chart for explaining a first control example of in the first embodiment;

FIG. 8 is a chart illustrating an example of a relation between the number of times of iteration in learning and the accuracy rate;

FIG. 9 is a chart for explaining a second control example in the first embodiment;

FIG. 10 is a flowchart illustrating the second control example in the first embodiment;

FIG. 11 is a chart for explaining a third control example in the first embodiment;

FIG. 12 is a flowchart illustrating the third control example in the first embodiment;

FIG. 13 is a diagram illustrating a configuration example of the neural network apparatus in the first embodiment;

FIG. 14 is a diagram illustrating a configuration example of a neural network apparatus in a second embodiment;

FIG. 15 is a flowchart illustrating a control example in the second embodiment;

FIG. 16 is a chart illustrating an example of energy in an undirectional graph neural network;

FIG. 17 is a chart for explaining a temperature parameter;

FIG. 18A and FIG. 18B are charts for explaining the temperature parameter;

FIG. 19 is a chart illustrating an example of a sigmoid function;

FIG. 20 is a chart for explaining a control example in the second embodiment;

FIG. 21A and FIG. 21B are charts illustrating an example of a hierarchical neural network;

FIG. 22 is a chart illustrating an example of the undirectional graph neural network;

FIG. 23A is a chart illustrating perceptron;

FIG. 23B and FIG. 23C are diagrams for explaining circuit mounting examples of the neural network; and

FIG. 24 is a diagram illustrating a configuration example of a conventional neural network apparatus.

### DESCRIPTION OF EMBODIMENTS

Hereinafter, embodiments will be explained with reference to drawings.

### First Embodiment

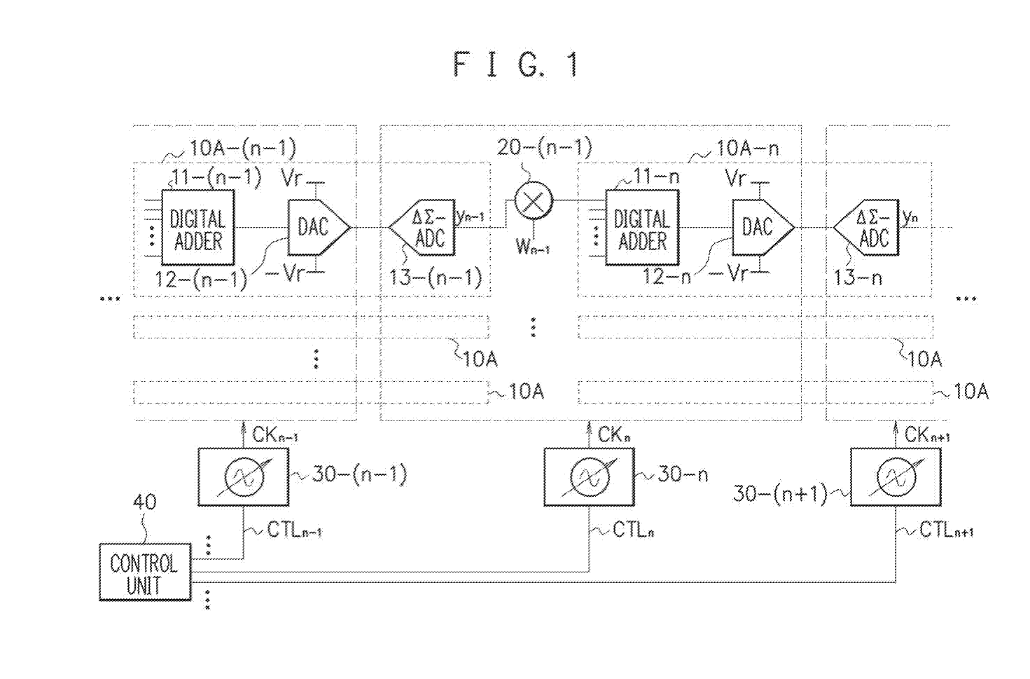

A first embodiment will be explained. FIG. 1 is a diagram illustrating a configuration example of a neural network apparatus in the first embodiment. The neural network apparatus illustrated in FIG. 1 includes a plurality of neuron units 10A, a plurality of digital arithmetic units 20, a plurality of variable frequency oscillators 30, and a control unit 40. The plurality of neuron units 10A and the plurality of digital arithmetic units 20 are connected to constitute a hierarchical neural network. Note that though a configuration relating to an (n−1)-th layer and an n-th layer in the neural network apparatus is illustrated in FIG. 1, a plurality of neuron units 10A in not-illustrated other layers are also connected to neuron units 10A in next layers via digital arithmetic units 20, thus forming a multilayer structure.

Each of the neuron units 10A includes a digital adder 11, a digital analog converter (DAC) 12, and a delta-sigma analog digital converter (ΔΣ-ADC) 13. The digital adder 11 adds all weighted input signals inputted into the neuron unit 10A to obtain a total sum. The DA converter 12 digital-analog converts a total sum value of weighted inputs outputted from the digital adder 11, and outputs an analog signal according to the total sum value. The ΔΣ-AD converter 13 analog-digital converts the analog signal outputted from the DA converter 12 into a pulse signal y as a digital signal according to the amplitude of the analog signal, and outputs the pulse signal y.

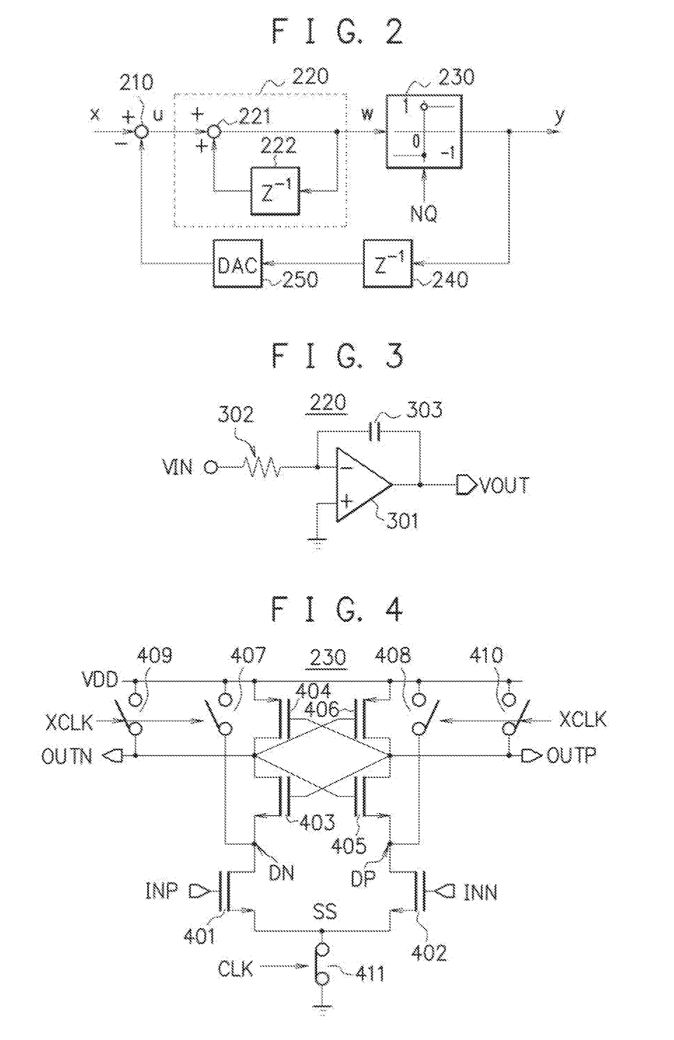

FIG. 2 is a diagram illustrating a configuration example of the ΔΣ-AD converter 13. In FIG. 2, a primary ΔΣ-AD converter is illustrated as an example. The ΔΣ-AD converter illustrated in FIG. 2 includes an adder (subtracter) 210, an integrator 220, a comparator (quantizer) 230, a delay circuit 240, and a digital analog converter (DAC) 250. The adder (subtracter) 210 subtracts the output from the DA converter 250 from an analog signal x inputted into the ΔΣ-AD converter, and outputs a result as a signal u.

The integrator 220 includes an adder 221 and a delay circuit 222. The adder 221 adds the signal u outputted from the adder (subtracter) 210 and an output from the delay circuit 222. The delay circuit 222 delays the output from the adder 221 and outputs a result. The integrator 220 integrates the signal u outputted from the adder (subtracter) 210 by using the adder 221 and the delay circuit 222, and outputs a result as a signal w. The integrator 220 is, for example, an analog integrator that includes an operational amplifier 301, a resistor 302, and a capacitor 303, and integrates an input signal VIN and outputs a result as an output signal VOUT.

The comparator (quantizer) 230 performs quantization processing on the signal w outputted from the integrator 220, and outputs a result as a 1-bit digital signal y. NQ denotes a quantization noise. The comparator 230 is, for example, a comparator whose circuit configuration is illustrated in FIG. 4. The comparator 230 illustrated in FIG. 4 operates in synchronization with a clock signal CLK to alternately perform a reset operation and a comparison operation in response to the clock signal CLK. When the clock signal CLK is at a low level, a switch 411 is turned off (an open state, a non-continuity state) and switches 407 to 410 that are controlled by an inversion signal XCLK of the clock signal CLK are turned on (a closed state, a continuity state), whereby the comparator 230 illustrated in FIG. 4 performs the reset operation. With this reset operation, the potentials at outputs OUTP, OUTN and nodes DP, DN are reset to VDD.

Further, when the clock signal CLK is at a high level, the switch 411 is turned on and the switches 407 to 410 are turned off, whereby the comparator 230 illustrated in FIG. 4 performs the comparison operation. In the comparison operation, currents according to analog inputs INP, INN flow by transistors 401, 402, and the potentials at the outputs OUTP, OUTN and the nodes DP, DN start to drop. Then, one output, which has sufficiently dropped first, of the outputs OUTP, OUTN becomes a low level, and the other output becomes a high level because it is latched by a latch circuit composed of transistors 403 to 406.

The delay circuit 240 delays the signal (the 1-bit digital signal y) outputted from the comparator 230 and outputs a result. The DA converter 250 digital-analog converts the digital signal delayed by the delay circuit 240 and outputs a result. The DA converter 250 gives a gain corresponding to a reciprocal of the gain of the comparator 230 to the analog signal to be outputted. Note that the configuration of the ΔΣ-AD converter and its internal configurations illustrated in FIG. 2 to FIG. 4 are examples, and the ΔΣ-AD converter is not limited to them. For example, though the primary ΔΣ-AD converter is exemplified as the ΔΣ-AD converter 13, the ΔΣ-AD converter 13 may be a secondary or higher-order ΔΣ-AD converter.

Returning to FIG. 1, the digital arithmetic unit 20 multiplies the digital signal inputted by the pulse signal y by a weight value w, and outputs a weighted signal. For example, a digital arithmetic unit 20-(n−1) in the (n−1)-th layer is arranged between a neuron unit 10A-(n−1) in the (n−1)-th layer and a neuron unit 10A-n in the n-th layer. An output yₙ₋₁ from the neuron unit 10A-(n−1) is weighted with a weight value wₙ₋₁ by the digital arithmetic unit 20-(n−1), and supplied to the neuron unit 10A-n. Also for a neuron unit 10A in another layer, the digital arithmetic unit 20 is arranged between the neuron unit 10A and a neuron unit 10A in a next layer, and performs weighting for a signal transmitted between the neuron units 10A.

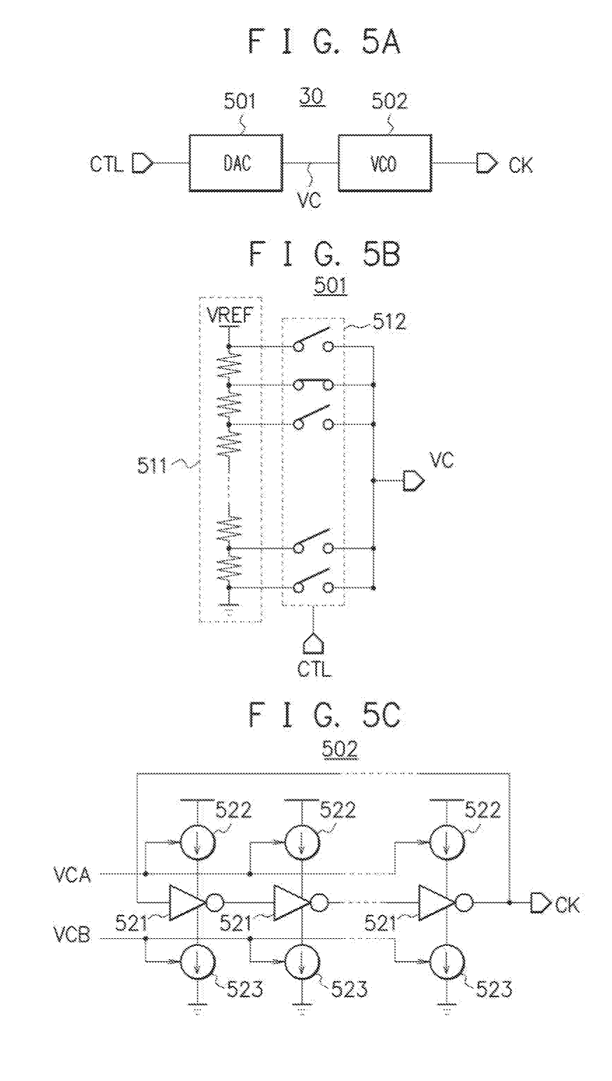

The variable frequency oscillator 30 is an oscillator capable of changing the frequency of a clock signal CK to be outputted, and outputs a clock signal CK having a frequency according to a control signal CTL outputted from the control unit 40. The control unit 40 performs control relating to functional units to control operations to be executed in the neural network apparatus. FIG. 5A is a diagram illustrating a configuration example of the variable frequency oscillator 30. The variable frequency oscillator 30 illustrated in FIG. 5A includes a DA converter (DAC) 501 that converts the control signal CTL inputted thereinto into a control voltage VC, and a voltage control oscillator (VCO) 502 that oscillates a clock signal CK having a frequency according to the control voltage VC.

The DA converter 501 includes, for example, a resistor ladder circuit 511 and a switch circuit 512 as illustrated in FIG. 5B. The resistor ladder circuit 511 includes a plurality of resistors each having a certain resistance value which are connected in series to subject a reference voltage VREF to resistance voltage division. The switch circuit 512 includes a plurality of switches controlled by the control signal CTL, and the plurality of switches have one ends connected to connection points of resistors different from each other in the resistor ladder circuit 511 and other ends commonly connected to an output end of a control voltage VC. By selectively turning on the plurality of switches of the switch circuit 512 according to the control signal CTL, the control voltage VC according to the control signal CTL is outputted.

The voltage control oscillator 502 is, for example, a ring oscillator in which an odd number of inverters 521 are connected as illustrated in FIG. 5C. Voltages VCA, VCB based on the control voltage VC control current sources 522, 523 to adjust the amount of current flowing through the inverters 521, thereby controlling the frequency of the clock signal CK. For example, when the amount of current flowing through the inverters 521 is increased, switching of the signal in the inverters 521 becomes faster to increase the frequency of the clock signal CK. Contrarily, when the amount of current flowing through the inverters 521 is decreased, switching of the signal in the inverters 521 becomes slower to decrease the frequency of the clock signal CK. Note that the configurations illustrated in FIG. 5A to FIG. 5C are examples and the configuration of the variable frequency oscillator 30 is not limited to the examples.

The neural network apparatus illustrated in FIG. 1 includes the variable frequency oscillator 30 in each layer. Here, the neuron unit 10A is composed of the digital adder 11, the DA converter 12, and the ΔΣ-AD converter 13, in which operations of the digital arithmetic unit 20, the digital adder 11, and the DA converter 12 are performed according to the pulse signal outputted from the ΔΣ-AD converter 13. Therefore, the variable frequency oscillator 30 supplies the clock signal CK to the ΔΣ-AD converter 13 and the digital arithmetic unit 20 in a layer one layer before a corresponding layer, and to the digital adder 11 and the DA converter 12 in the corresponding layer.

For example, a variable frequency oscillator 30-(n−1) in the (n−1)-th layer supplies a clock signal CKₙ₋₁ having a frequency according to a control signal CTLₙ₋₁ relating to the (n−1)-th layer to a ΔΣ-AD converter and a digital arithmetic unit (not illustrated) in an (n−2)-th layer, and to a digital adder 11-(n−1) and a DA converter 12-(n−1) in the (n−1)-th layer. A variable frequency oscillator 30-n in the n-th layer supplies a clock signal CKₙ having a frequency according to a control signal CTLₙ relating to the n-th layer to a ΔΣ-AD converter 13-(n−1) and the digital arithmetic unit 20-(n−1) in the (n−1)-th layer, and to a digital adder 11-n and a DA converter 12-n in the n-th layer. A ΔΣ-AD converter 13-n in the n-th layer is supplied with a clock signal CKₙ₊₁ having a frequency according to a control signal CTLₙ₊₁ relating to an (n+1)-th layer from a variable frequency oscillator 30-(n+1) in the (n+1)-th layer.

Arranging the variable frequency oscillator 30 capable of changing the frequency of the clock signal CK to be outputted for each layer in the neural network apparatus makes it possible to set the operating frequency for each layer. Thus, a layer required to have high accuracy (SNR) is made to operate with high frequency to reduce the quantization noise existing in a frequency band of the input signal by noise shaping, and the other layers are made to operate with low frequency to suppress power consumption. Accordingly, it is possible to suppress and reduce the power consumption in the whole neural network apparatus while keeping high accuracy. Further, by controlling the operating frequency according to the accuracy (SNR) required, even the same layer is made to operate with low frequency to suppress power consumption in a period when low accuracy is allowable and made to operate with high frequency in a period when high accuracy is required, thereby making it possible to achieve a balance between the power consumption and the accuracy.

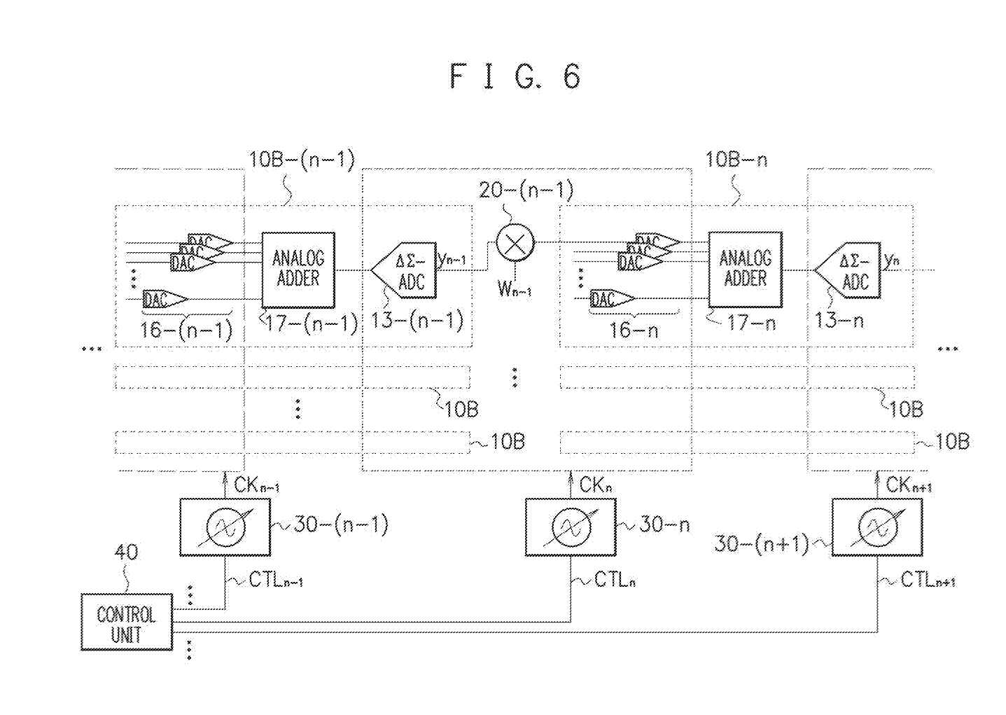

FIG. 6 is a diagram illustrating another configuration example of the neural network apparatus in the first embodiment. In FIG. 6, the same numerals are given to components having the same functions as those illustrated in FIG. 1 to omit redundant explanation. The above-explained neural network apparatus illustrated in FIG. 1 obtains the total sum of the weighted inputs using the digital adder, whereas the neural network apparatus illustrated in FIG. 6 obtains the total sum of the weighted inputs using an analog adder. The neural network apparatus illustrated in FIG. 6 is different from the neural network apparatus illustrated in FIG. 1 in the configuration of a neuron unit 10B corresponding to the neuron unit 10A and in the objects to be supplied with the clock signal CK from the variable frequency oscillator 30, and is the same with the neural network apparatus illustrated in FIG. 1 in others.

Each of the neuron units 10B includes DA converters (DACs) 16, an analog adder 17, and a ΔΣ-AD converter ΔΣ-AD converter (ΔΣ-ADC) 13. The DA converters 16 individually digital-analog convert weighted inputs inputted into the neuron unit 10B, and output analog signals according to the weighted inputs. The analog adder 17 adds the analog signals outputted individually from the DA converters 16 to obtain a total sum. The ΔΣ-AD converter 13 analog-digital converts the analog signal outputted from the analog adder 17 into a pulse signal y as a digital signal according to the amplitude of the analog signal, and outputs the pulse signal y.

As in the neural network apparatus illustrated in FIG. 1, for example, a digital arithmetic unit 20-(n−1) in an (n−1)-th layer is arranged between a neuron unit 10B-(n−1) in the (n−1)-th layer and a neuron unit 10B-n in an n-th layer. An output yₙ₋₁ from the neuron unit 10B-(n−1) is weighted with a weight value wₙ₋₁ by the digital arithmetic unit 20-(n−1), and supplied to the neuron unit 10B-n. Also for a neuron unit 10B in another layer, the digital arithmetic unit 20 is arranged between the neuron unit 10B and a neuron unit 10B in a next layer, and performs weighting for a signal transmitted between the neuron units 10B.

Also the neural network apparatus illustrated in FIG. 6 includes, in each layer, the variable frequency oscillator 30 capable of changing the frequency of the clock signal CK to be outputted. However, in the configuration illustrated in FIG. 6, the processing in the analog adder 17 is performed only with the analog signals, and therefore the clock signal CK from the variable frequency oscillator 30 is not supplied to the analog adder 17. In other words, the variable frequency oscillator 30 supplies the clock signal CK to the ΔΣ-AD converter 13 and the digital arithmetic unit 20 in a layer one layer before a corresponding layer, and to the DA converter 12 in the corresponding layer.

For example, a variable frequency oscillator 30-(n−1) in the (n−1)-th layer supplies a clock signal CKₙ₋₁ having a frequency according to a control signal CTLₙ₋₁ relating to the (n−1)-th layer to a ΔΣ-AD converter and a digital arithmetic unit (not illustrated) in an (n−2)-th layer, and to a DA converter 16-(n−1) in the (n−1)-th layer. A variable frequency oscillator 30-n in the n-th layer supplies a clock signal CKₙ having a frequency according to a control signal CTLₙ relating to the n-th layer to a ΔΣ-AD converter 13-(n−1) and the digital arithmetic unit 20-(n−1) in the (n−1)-th layer, and to a DA converter 16-n in the n-th layer. A ΔΣ-AD converter 13-n in the n-th layer is supplied with a clock signal CKₙ₋₁ having a frequency according to a control signal CTLₙ₊₁ relating to an (n+1)-th layer from a variable frequency oscillator 30-(n+1) in the (n+1)-th layer.

Also in the thus configured neural network apparatus illustrated in FIG. 6, it is possible to set the operating frequency for each layer, and allow a layer required to have high accuracy (SNR) to operate with high frequency to thereby reduce the quantization noise existing in a frequency band of the input signal by noise shaping, and allow the other layers to operate with low frequency to thereby suppress power consumption. Accordingly, it is possible to suppress and reduce the power consumption in the whole neural network apparatus while keeping high accuracy. Further, by controlling the operating frequency according to the accuracy (SNR) required, even the same layer is made to operate with low frequency to suppress power consumption in a period when low accuracy is allowable and made to operate with high frequency in a period when high accuracy is required, thereby making it possible to achieve a balance between the power consumption and the accuracy.

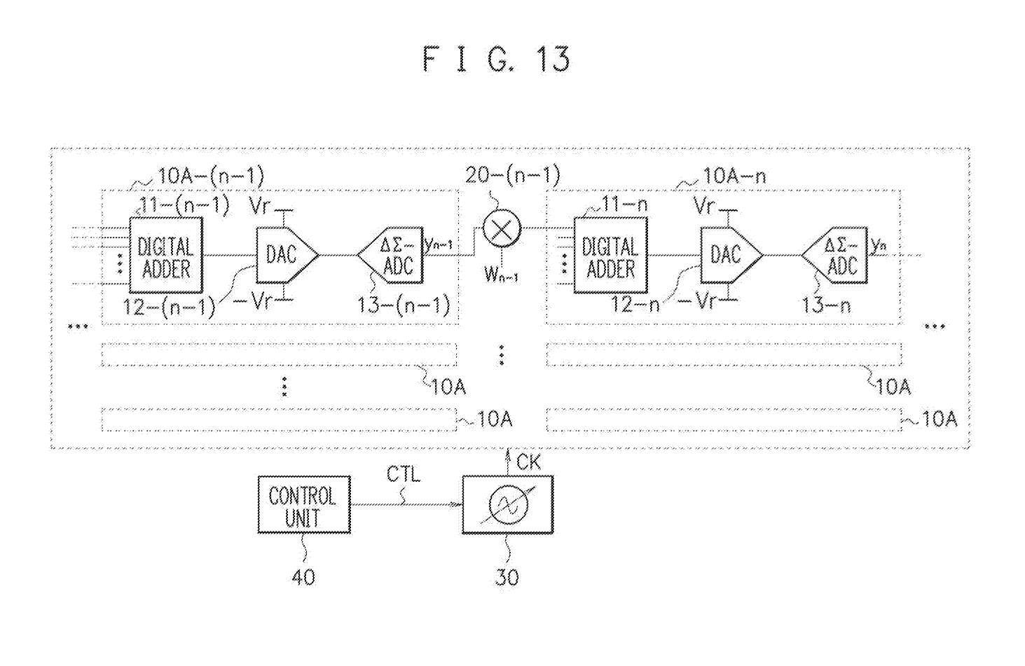

Note that the neural network apparatus including the variable frequency oscillator 30 in each layer is illustrated in the above-explained configuration example, but the neural network apparatus is not limited to this configuration, and the clock signal CK may be supplied from one variable frequency oscillator 30 to a plurality of layers. Besides, the clock signal CK may be supplied from one variable frequency oscillator 30 to all of the neuron units 10A(10B) and the digital arithmetic units 20 as illustrated, for example, in FIG. 13. Even this configuration can suppress the power consumption, as compared with the case of supplying the clock signal having a fixed frequency at all times, by changing the frequency of the clock signal supplied according to the required accuracy.

Next, a control example of the neural network apparatus of the hierarchical neural network in the first embodiment will be explained.

### First Control Example

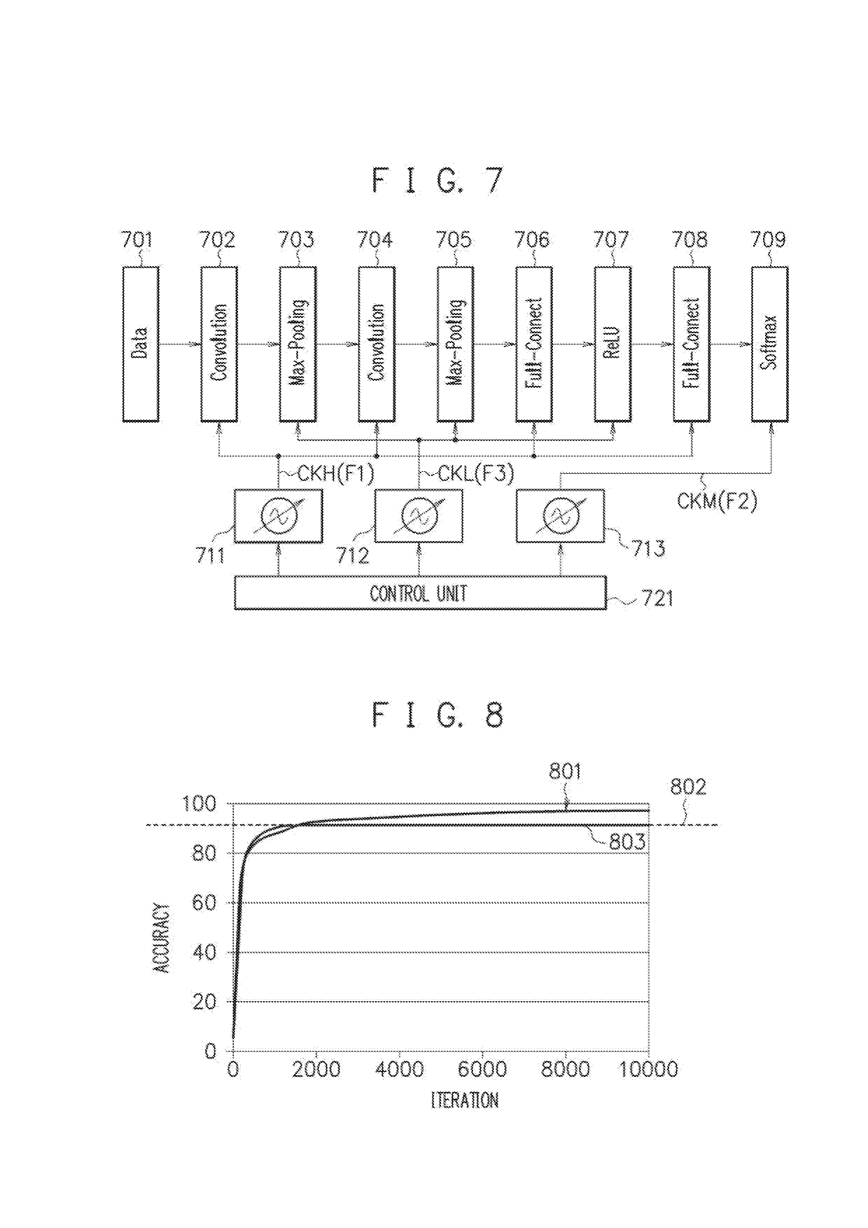

A first control example in which the neuron unit and the digital arithmetic unit are made to operate with an operating frequency according to the required level of the accuracy (SNR) for each layer in the neural network apparatus will be explained. FIG. 7 is a chart for explaining the first control example of the neural network apparatus in the first embodiment. FIG. 7 illustrates a neural network apparatus relating to a convolutional neural network called a LeNet being a type of the hierarchical neural network. The LeNet is used, for example, for recognition of handwritten numerals and the like. In each of layers of the neural network apparatus illustrated in FIG. 7, a plurality of neuron units are arranged, and neuron units in different layers are connected via digital arithmetic units.

In a convolution layer 702, a product-sum operation of input data 701 of an image and a numerical value of a filter is repeated, and a result of the product-sum operation is outputted to a next layer via an output function. In a max-pooling layer 703, processing of selecting an output having a high numerical value from a certain block in the output from the convolution layer 702 in order to reduce the calculation amount is performed to reduce the number of data pieces. In a convolution layer 704, the same processing as in the convolution layer 702 is performed using the output data from the max-pooling layer 703. In a max-pooling layer 705, the same processing as in the max-pooling layer 703 is performed on the output from the convolution layer 704.

In a full-connect layer 706, the output value from each of neuron units in the max-pooling layer 705 are weighted and added all together. In a reLU layer 707, an output having a negative value of the outputs from the max-pooling layer 705 is converted into 0. In a full-connect layer 708, output values from neuron units in the reLU layer 707 are weighted and added all together. In a softmax layer 709, final recognition is performed to determine what is the input data 701. The convolution layers 702, 704 and the full-connect layers 706, 708 of the above-explained layers are required to perform extremely many arithmetic operations and have high accuracy. On the other hand, the max-pooling layers 703, 705 and the reLU layer 707 may have low accuracy. The softmax layer 709 is required to have accuracy at a middle level though it is not required to have an accuracy as high as those of the convolution layers 702, 704 and the full-connect layers 706, 708.

Hence, as illustrated in FIG. 7, three variable frequency oscillators 711, 712, 713 are provided, and the frequencies of clock signals outputted from the variable frequency oscillators 711, 712, 713 are controlled by a control unit 721. To neuron units and digital arithmetic units relating to the convolution layers 702, 704 and the full-connect layers 706, 708 which are required to have high accuracy, the variable frequency oscillator 711 supplies a clock signal CKH having a high frequency F1. Besides, to neuron units and digital arithmetic units relating to the max-pooling layers 703, 705 and the reLU layer 707 which may have low accuracy, the variable frequency oscillator 712 supplies a clock signal CKL having a low frequency F3 (F3<F1). Besides, to neuron units and digital arithmetic units relating to the softmax layer 709 which is required to have accuracy at a middle level, the variable frequency oscillator 713 supplies a clock signal CKM having a frequency F2 at a middle level (F3<F2<F1).

Supplying a clock signal with an appropriate frequency to each of the layers in the neural network apparatus makes it possible to operate the neuron units and the digital arithmetic units in each layer with the appropriate frequency, thereby reducing power consumption as compared with the case of operating all of them with the same constant frequency. Further, the neuron units and the digital arithmetic units in the layer which are required to have high accuracy are made to operate with high frequency and thereby can keep high accuracy without decreasing the accuracy.

### Second Control Example

Next, a second control example of performing a test every time a certain number of times of learning is iterated and detecting an accuracy rate, and switching the operating frequency of the neuron units and the digital arithmetic units according to the detection result will be explained. In the case where learning is performed at a certain constant learning rate in the hierarchical neural network, the accuracy rate, at the time when performing a test every time a certain number of times of learning is iterated, changes like an accuracy rate 801 illustrated in FIG. 8, and the accuracy rate approaches 100% in iteration of learning. In FIG. 8, the vertical axis represents the accuracy rate (%), and the horizontal axis represents the number of times of iteration.

In the neural network apparatus mounted with a circuit of the hierarchical neural network as explained above, it is considered that, in the case of a low SNR, when the accuracy rate increases, the value calculated in the learning is buried in noise and the accuracy rate does not increase even if the iteration of learning is repeated. For example, as illustrated in FIG. 8, when the iteration of learning is repeated and the accuracy rate reaches a limit value 802 of the accuracy rate by the SNR, the accuracy rate does not increase any longer like an accuracy rate 803 illustrated in FIG. 8 even if the iteration of learning is repeated thereafter.

To solve the above, it is only necessary to perform operation with high operating frequency to increase the SNR to thereby increase the accuracy of the circuit. However, the operation with high operating frequency from the start of learning is waste of power consumption. In the second control example, the operating frequency of the neuron units and the digital arithmetic units is switched according to the detected accuracy rate to perform control to increase stepwise the operating frequency. In more detail, when the accuracy rate at the time when performing a test every time a certain number of times of learning is iterated is not higher than the accuracy rate at the previous time, namely, is equal to or lower than the accuracy rate at the previous time, the operating frequency is switched to an operating frequency at a next stage that is higher than the current operating frequency.

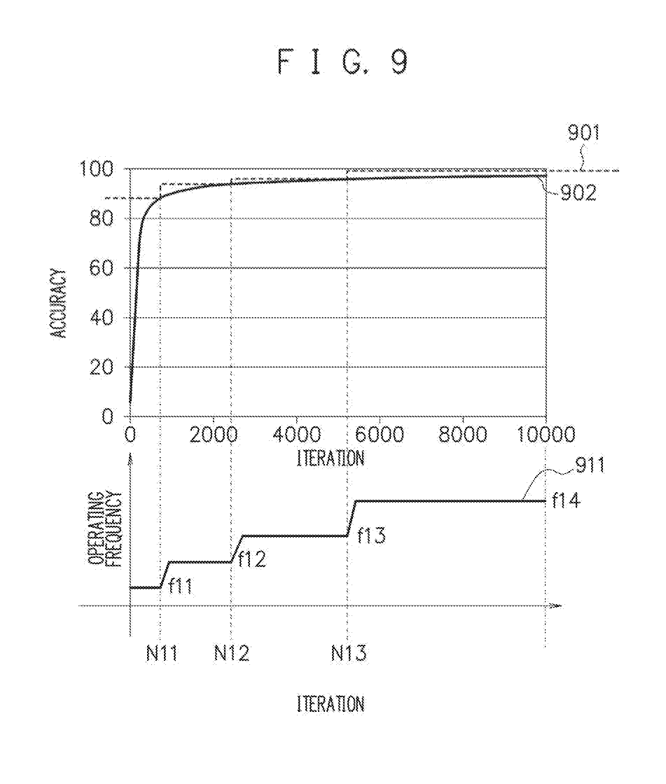

For example, as in an example illustrated in FIG. 9, when learning is started with a low operating frequency f11, iteration of learning is repeated, and the accuracy rate becomes equal to or lower than the accuracy rate at the previous time at a number of times of iteration N11, an accuracy rate 902 is regarded as having reached a limit value 901 by the SNR, an operating frequency 911 is switched to a frequency f12 higher than the frequency f11, and the iteration of learning is repeated. Thereafter, in a similar manner, when the accuracy rate becomes equal to or lower than the accuracy rate at the previous time at a number of times of iteration N12, the operating frequency 911 is switched to a frequency f13 higher than the frequency f12, and the iteration of learning is repeated. When the accuracy rate becomes equal to or lower than the accuracy rate at the previous time at a number of times of iteration N13, the operating frequency 911 is switched to a frequency f14 higher than the frequency f13, and the iteration of learning is repeated. Such a control makes it possible to control the operating frequency 911 so as to gradually increase the limit value 901 of the accuracy rate by the SNR according to the accuracy rate 902, thereby suppressing the power consumption while obtaining an appropriate accuracy.

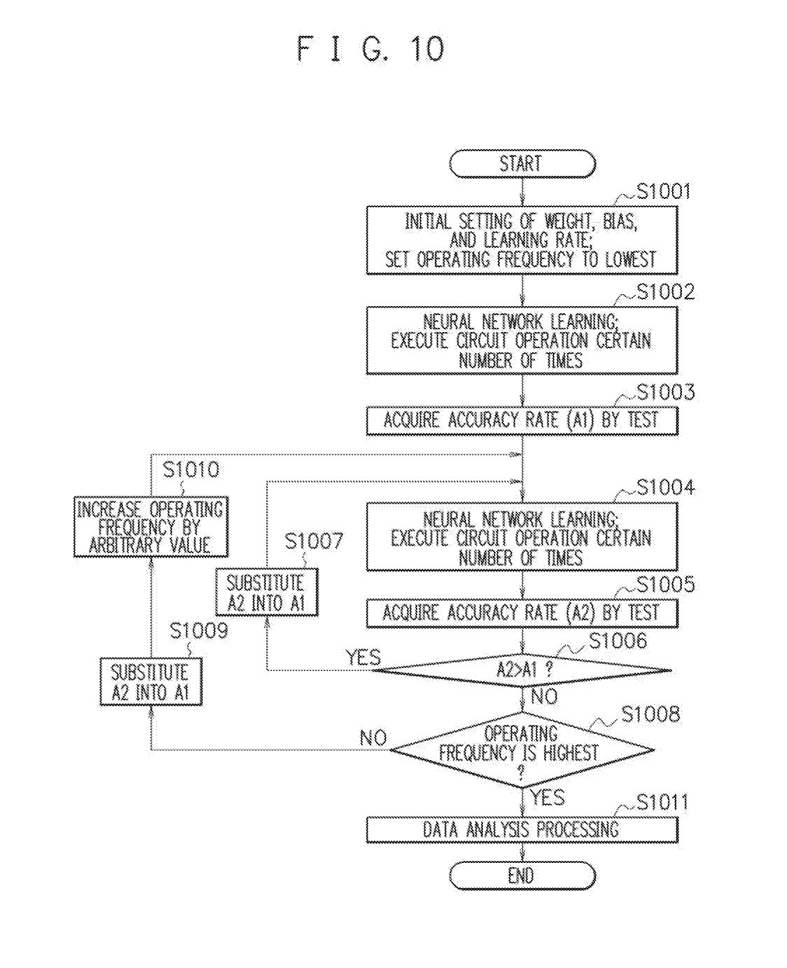

FIG. 10 is a flowchart illustrating the operation in the second control example. First, at step S1001, the control unit 40 sets a bias value, a weight value, and a learning rate to each of the neuron units 10A(10B) and digital arithmetic units 20 of the neural network apparatus. The control unit 40 further sets the operating frequency to a lowest set value (initial value), and outputs a control signal CTL according to the lowest set value to the variable frequency oscillator 30. Thus, the clock signal CK having the frequency of the lowest set value is supplied from the variable frequency oscillator 30 to each of the neuron units 10A(10B) and digital arithmetic units 20.

At step S1002, the control unit 40 starts learning in the neural network apparatus to execute the circuit operation a certain number of times. Then, after the circuit operation performed the certain number of times, the control unit 40 performs a test to acquire an accuracy rate (A1) at step S1003.

Next, at step S1004, the control unit 40 performs learning in the neural network apparatus to execute the circuit operation a certain number of times. Then, after the circuit operation performed the certain number of times, the control unit 40 performs a test to acquire an accuracy rate (A2) at step S1005. Subsequently, at step S1006, the control unit 40 compares the accuracy rate (A1) being the accuracy rate acquired at the previous time and the accuracy rate (A2) being the accuracy rate acquired at this time. When the accuracy rate (A2) is higher than the accuracy rate (A1) as a result, namely, the accuracy rate by the test at this time is higher than the accuracy rate by the test at the previous time, the control unit 40 substitutes the accuracy rate (A2) into the accuracy rate (A1) (updates with the accuracy rate (A2) as the accuracy rate (A1)) at step S1007, and returns to step S1004 and performs learning without changing the operating frequency.

On the other hand, when the accuracy rate (A2) is not higher than the accuracy rate (A1) as a result of the comparison at step S1006, namely, the accuracy rate by the test at this time is equal to or lower than the accuracy rate by the test at the previous time, the control unit 40 determines whether the current operating frequency is the highest set value or not at step S1008. When the current operating frequency is not the highest set value, the control unit 40 substitutes the accuracy rate (A2) into the accuracy rate (A1) (updates with the accuracy rate (A2) as the accuracy rate (A1)) at Step S1009, and increases the operating frequency by an arbitrary value (sets the operating frequency to an operating frequency at a next stage) at step S1010, and returns to step S1004 and performs learning with an operating frequency higher than the operating frequency at the previous time (with an increased SNR).

On the other hand, when the current operating frequency is the highest set value as a result of the determination at step S1008, the control unit 40 performs control relating to data analysis processing of executing final processing at step S1011, and obtains a final result and then ends the operation. Note that the processing at step S1009 and the processing at step S1010 which are explained above are not in order, and the processing at step S1010 may be performed before the processing at step S1009 or may be performed concurrently with the processing at step S1009.

### Third Control Example

Next, a third control example of controlling switching of the operating frequency of the neuron units and the digital arithmetic units according to the number of times of iteration of learning (learning rate) in the neural network apparatus will be explained. For example, in an AlexNet being a type of the hierarchical neural network, when the learning rate is decreased every time a certain number of times of learning is iterated, and learning is further iterated, the accuracy rate improves. In the case of performing control to decrease the learning rate every time a certain number of times of learning is iterated, it is conceivable that, in the case of a low SNR, when the learning rate is decreased, the value calculated in the learning is buried in noise and the learning is not normally performed.

The above-explained inconvenience can be solved by operation with high operating frequency to increase the SNR. However, the operation with high operating frequency from the start of learning where the learning rate is set to be high is waste of power consumption. In the third control example, in the neural network apparatus controlled to decrease the learning rate every time a certain number of times of learning is iterated, the operating frequency of the neuron units and the digital arithmetic units is switched according to the number of times of iteration of learning (learning rate) to increase the operating frequency stepwise.

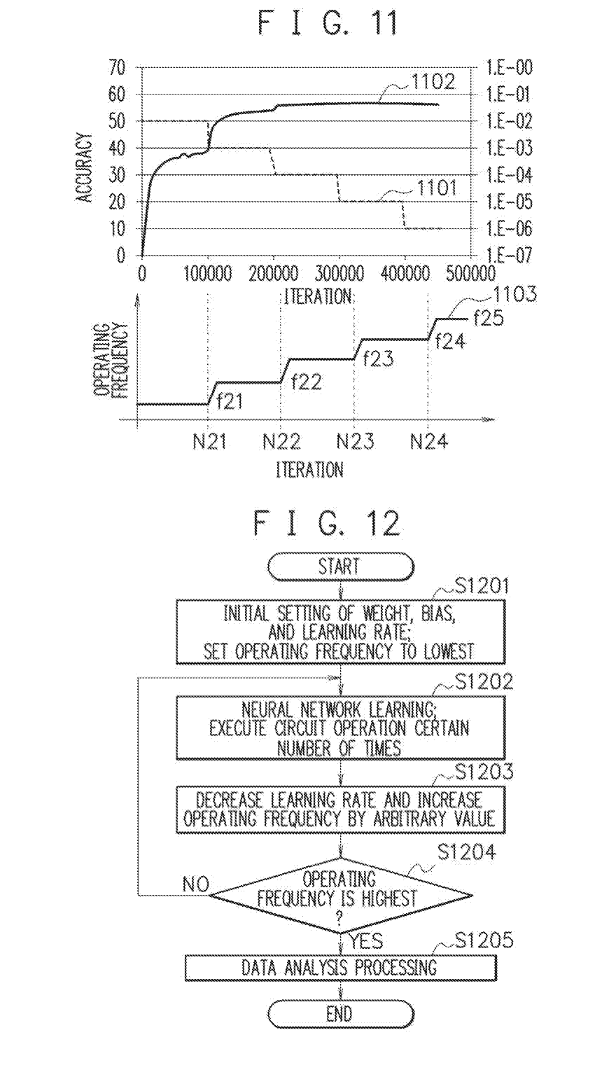

For example, as in an example illustrated in FIG. 11, learning is started with a low operating frequency f21, iteration of learning is repeated, and an operating frequency 1103 is switched to a frequency f22 higher than the frequency f21 accompanying a decrease of a learning rate 1101 at a number of times of iteration N21, and the iteration of learning is repeated. Thereafter, in a similar manner, the operating frequency 1103 is switched to a frequency f23 higher than the frequency f22 accompanying a decrease of the learning rate 1101 at a number of times of iteration N22, the operating frequency 1103 is switched to a frequency f24 higher than the frequency f23 accompanying a decrease of the learning rate 1101 at a number of times of iteration N23, the operating frequency 1103 is switched to a frequency f25 higher than the frequency f24 accompanying a decrease of the learning rate 1101 at a number of times of iteration N24, and the iteration of learning is repeated. Such a control makes it possible to increase the operating frequency 1103 according to the decrease of the learning rate 1101 so as to increase the SNR, thereby suppressing the power consumption while obtaining an appropriate accuracy to realize efficient learning and obtain a learning rate 1102.

FIG. 12 is a flowchart illustrating the operation in the third control example. First, at step S1201, the control unit 40 sets a bias value and a weight value to each of the neuron units 10A(10B) and digital arithmetic units 20 of the neural network apparatus, and sets a learning rate to the highest set value. The control unit 40 further sets the operating frequency to a lowest set value (initial value), and outputs a control signal CTL according to the lowest set value to the variable frequency oscillator 30. Thus, the clock signal CK having the frequency of the lowest set value is supplied from the variable frequency oscillator 30 to each of the neuron units 10A(10B) and digital arithmetic units 20.

Next, at step S1202, the control unit 40 performs learning in the neural network apparatus to execute the circuit operation a certain number of times. Then, after the circuit operation performed the certain number of times, the control unit 40 decreases the learning rate to a learning rate at a next stage and increases the operating frequency by an arbitrary value (sets the operating frequency to that at the next stage) at step S1203. Subsequently, at step S1204, the control unit 40 determines whether the operating frequency is the highest set value or not. When the operating frequency is not the highest set value, the control unit 40 returns to step S1202 and performs learning with an operating frequency higher than the operating frequency at the previous time (with an increased SNR). On the other hand, when the operating frequency is the highest set value, the control unit 40 performs control relating to data analysis processing of executing final processing at step S1205, and obtains a final result and then ends the operation.

### Second Embodiment

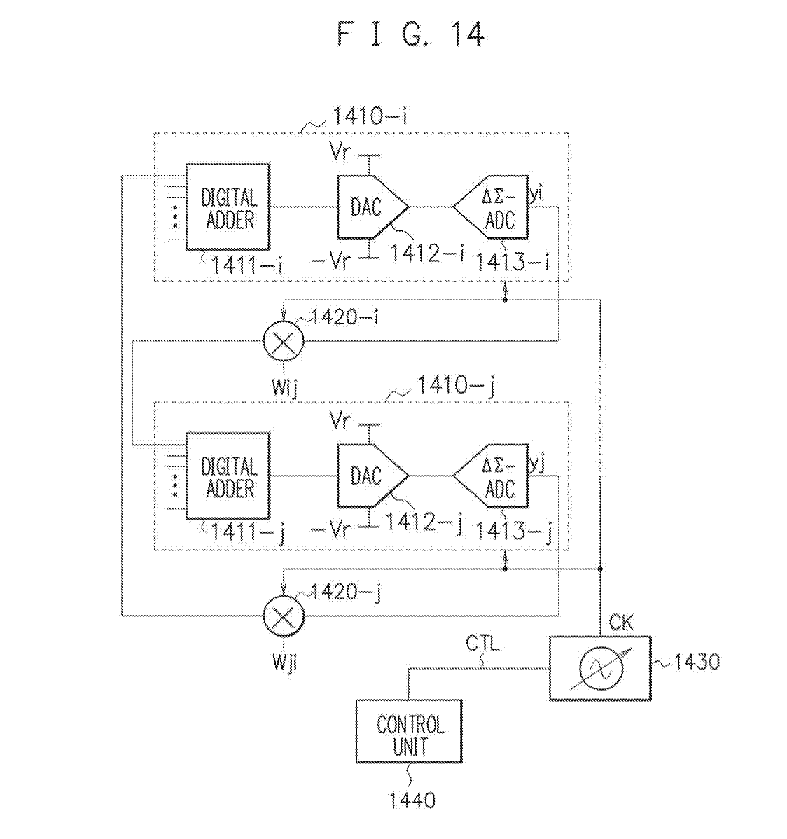

Next, a second embodiment will be explained. FIG. 14 is a diagram illustrating a configuration example of a neural network apparatus in the second embodiment. The neural network apparatus illustrated in FIG. 14 includes a plurality of neuron units 1410, a plurality of digital arithmetic units 1420, a variable frequency oscillator 1430, and a control unit 1440.

In the neural network apparatus illustrated in FIG. 14, the plurality of neuron units 1410 are connected via the digital arithmetic units 1420 to affect each other to thereby constitute an undirectional graph neural network. For example, an output yi from an ith neuron unit 1410-i is weighted with a weight value Wij by a digital arithmetic unit 1420-i, and inputted into a j-th neuron unit 1410-j. Further, an output yj from the j-th neuron unit 1410-j is weighted with a weight value Wji by a digital arithmetic unit 1420-j, and inputted into the i-th neuron unit 1410-i. Here, the weight value Wij and the weight value Wji are the same value. Note that FIG. 14 illustrates a configuration relating to the i-th neuron unit 1410-i and the j-th neuron unit 1410-j in the neural network apparatus, and not-illustrated other neuron units 1410 are also connected to other neuron units 1410 via digital arithmetic units 1420.

Each of the neuron units 1410 includes a digital adder 1411, a DA converter (DAC) 1412, and a ΔΣ-AD converter (ΔΣ-ADC) 1413. The digital adder 1411 adds all weighted input signals inputted into the neuron unit 1410 to obtain a total sum. The DA converter 1412 digital-analog converts a total sum value of the weighted inputs outputted from the digital adder 1411, and outputs an analog signal according to the total sum value. The ΔΣ-AD converter 1413 analog-digital converts the analog signal outputted from the DA converter 1412 into a pulse signal y as a digital signal according to the amplitude of the analog signal, and outputs the pulse signal y.

The digital arithmetic unit 1420 multiplies the digital signal inputted by the pulse signal y by a weight value w, and outputs a weighted signal. The variable frequency oscillator 1430 is an oscillator capable of changing the frequency of a clock signal CK to be outputted, and outputs a clock signal CK having a frequency according to a control signal CTL outputted from the control unit 1440, to all of the neuron units 1410 and the digital arithmetic units 1420 of the neural network apparatus. The control unit 1440 performs control relating to functional units to control operations to be executed in the neural network apparatus.

Note that the configuration of the ΔΣ-AD converter 1413 and its internal configurations and the configuration of the variable frequency oscillator 1430 are the same as the configuration of the ΔΣ-AD converter 13 and its internal configurations and the configuration of the variable frequency oscillator 30 in the first embodiment. Besides, the neuron unit 1410 obtains the total sum of the weighted inputs using the digital adder in FIG. 14, but may be a circuit that obtains the total sum of the weighted inputs using an analog adder similarly to the neuron unit 10B in the first embodiment. In the case of using the neuron unit that obtains the total sum of the weighted inputs using the analog adder, the variable frequency oscillator 1430 supplies the clock signal CK having the frequency according to the control signal CTL to the DA converters and the ΔΣ-AD converters of the neuron units 1410 and to the digital arithmetic units.

Arranging the variable frequency oscillator 1430 capable of changing the frequency of the clock signal CK to be outputted makes it possible to change the operating frequency in the neural network apparatus according to the required accuracy, the temperature parameter in the Boltzmann machine and the like. This makes it possible to suppress and reduce the power consumption in the whole neural network apparatus while keeping high accuracy to achieve a balance between the power consumption and the accuracy. For example, the neural network apparatus is made to operate with high frequency to reduce the quantization noise existing in a frequency band of the input signal by noise shaping in a period when high accuracy is required, whereas the neural network apparatus is made to operate with low frequency to suppress the power consumption in a period when low accuracy is allowable.

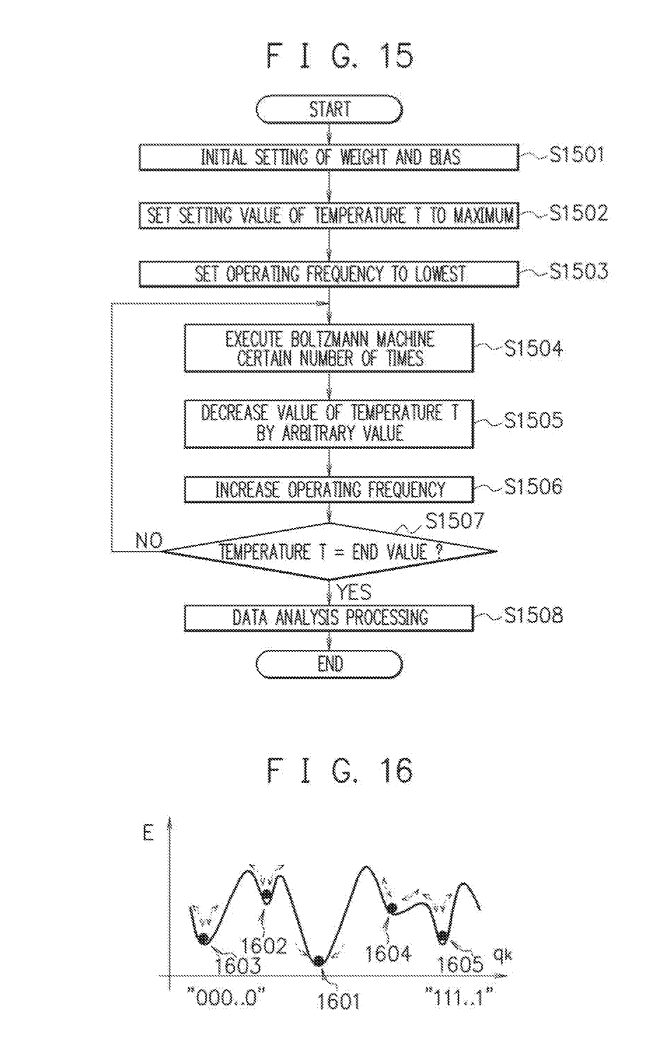

Next, a control example of the neural network apparatus of the undirectional graph neural network in the second embodiment will be explained. FIG. 15 is a flowchart illustrating the operation in the control example in the second embodiment. First, at step S1501, the control unit 1440 sets a bias value and a weight value to each of the neuron units 1410 and digital arithmetic units 20 of the neural network apparatus. Next, at step S1502, the control unit 1440 sets a temperature parameter T to a maximum set value. The temperature parameter T is a parameter for controlling the gradient of the sigmoid function, in other words, the probability of making a mistake between outputs 0 (−1) and 1 with respect to the input value.

The temperature parameter in the Boltzmann machine will be explained. FIG. 16 is a chart illustrating an example of energy in the undirectional graph neural network. In the undirectional graph neural network, an optimal solution 1601 where energy has a minimum value is obtained for the purpose of minimizing energy. However, if there are local solutions 1602, 1603, 1604, 1605 where energy becomes locally low, the steepest descent method or the like does not reach the optimal solution 1601 when energy converges to any of the local solutions 1602 to 1605.

In the Boltzmann machine, application of heat noise enables shift also to a direction where energy increases in a certain magnitude, so that the heat noise increases with a larger value of the temperature parameter T to enable a shift to a state with a large energy difference. For example, in the Boltzmann machine, application of appropriate heat noise by the temperature parameter T enables convergence to the optimal solution 1601 by performing the circuit operation even if energy converges to the local solutions 1602 to 1605.

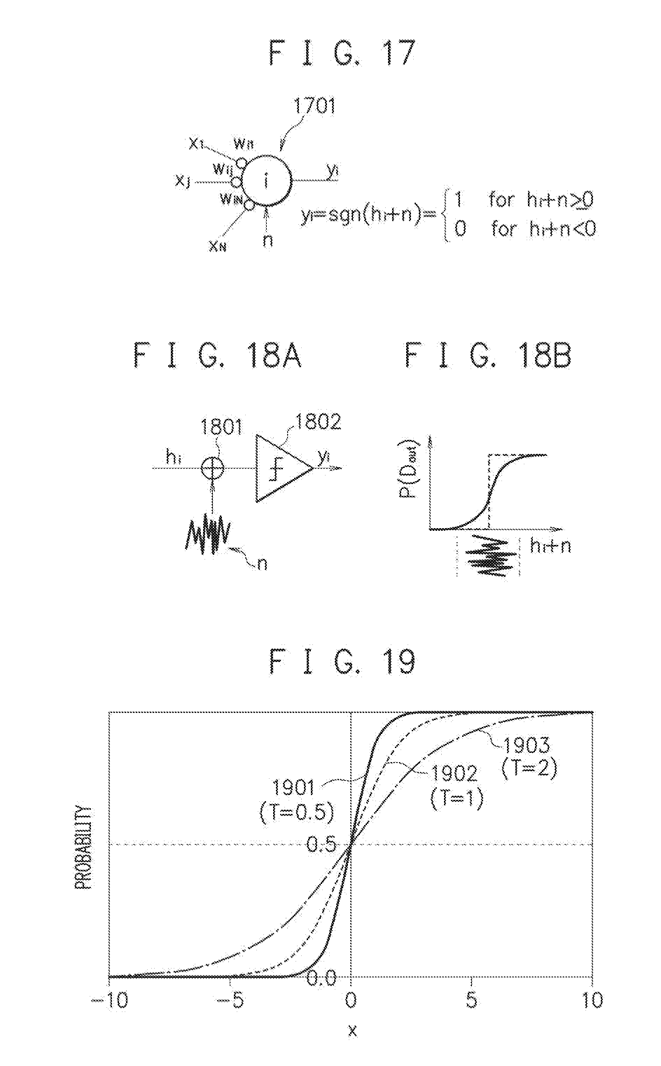

For example, an artificial neuron 1701 is assumed to output 1 when a value obtained by adding a noise n to a local field hi (=x₁w₁ₗ+ . . . +xⱼwᵢⱼ+ . . . +xₙw_{iN}+bi) being a total sum of the weighted inputs is 0 or more, and output 0 when it is less than 0 as illustrated in FIG. 17. The artificial neuron 1701 illustrated in FIG. 17 can be realized by an adder 1801 that adds the local field hi and the noise n, and a comparator 1802 that compares whether or not the output from the adder 1801 is 0 or more and outputs a comparison result as illustrated in FIG. 18A. The probability that an output yᵢ from the comparator 1802 is 1 becomes a step function as illustrated with a broken line in FIG. 18B when there is no noise n, and comes to have a gradient with respect to the change in local field as illustrated with a solid line in FIG. 18B when the noise n is applied thereto.

The function indicating the probability is the sigmoid function, and the gradient of the probability changing according to the value of the temperature parameter T changes as in an example illustrated in FIG. 19. In FIG. 19, the horizontal axis represents the input value, and the vertical axis represents the probability that 1 is outputted as the output. A solid line 1901 indicates the probability when the temperature parameter T is 0.5, a broken line 1902 indicates the probability when the temperature parameter T is 1, and a one-dotted chain line 1903 indicates the probability when the temperature parameter T is 2. As explained above, the sigmoid function has a gradual change (small gradient) in the probability when the value of the temperature parameter T is large, and has a rapid change (large gradient) in the probability when the value of the temperature parameter T is small.

Returning to FIG. 15, after the temperature parameter T is set to the maximum set value at step S1502, the control unit 1440 sets the operating frequency to a lowest set value (initial value) at step S1503, and outputs a control signal CTL according to the lowest set value to the variable frequency oscillator 1430. Thus, the clock signal CK having the frequency of the lowest set value is supplied from the variable frequency oscillator 1430 to each of the neuron units 1410 and digital arithmetic units 1420.

Next, at step S1504, the control unit 1440 executes the circuit operation of the neural network apparatus (Boltzmann machine) a certain number of times. Then, after the circuit operation performed the certain number of times, the control unit 1440 decreases the value of the temperature parameter T by an arbitrary value at step S1505, and increases the operating frequency by an arbitrary value at step S1506. Subsequently, at step S1507, the control unit 1440 determines whether the value of the temperature parameter T is a minimum set value (end value). When the value of the temperature parameter T is not the minimum set value (end value), the control unit 1440 returns to step S1504 and performs the circuit operation with an operating frequency higher than the operating frequency at the previous time (with an increased SNR). On the other hand, when the value of the temperature parameter T is the minimum set value (end value), the control unit 1440 performs control relating to data analysis processing of executing final processing at step S1508, and obtains a final result and then ends the operation.

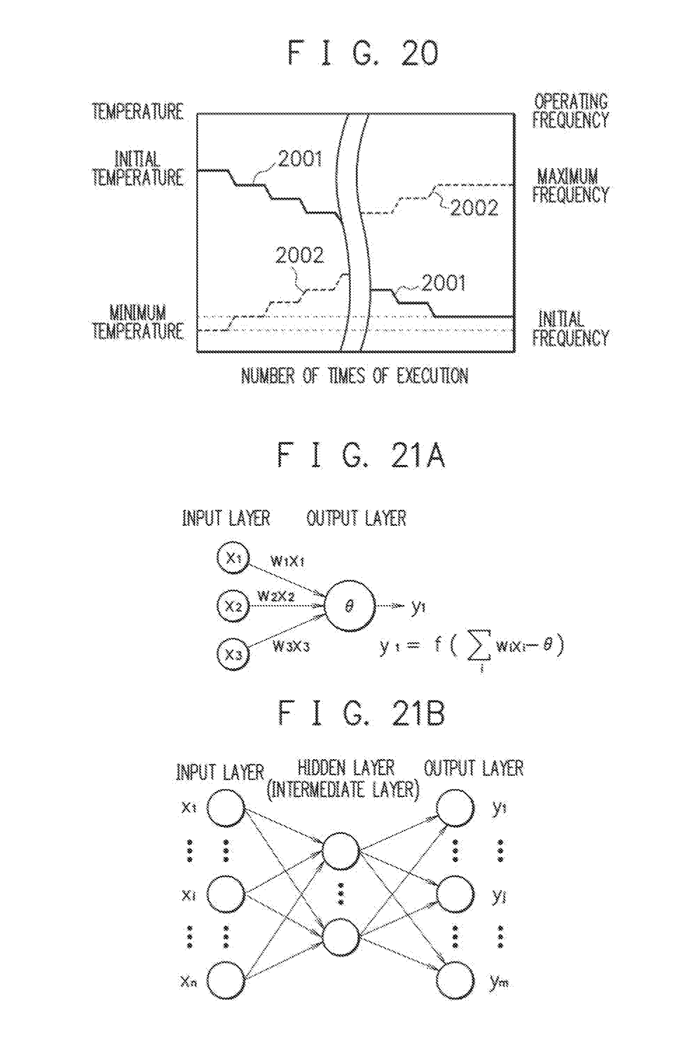

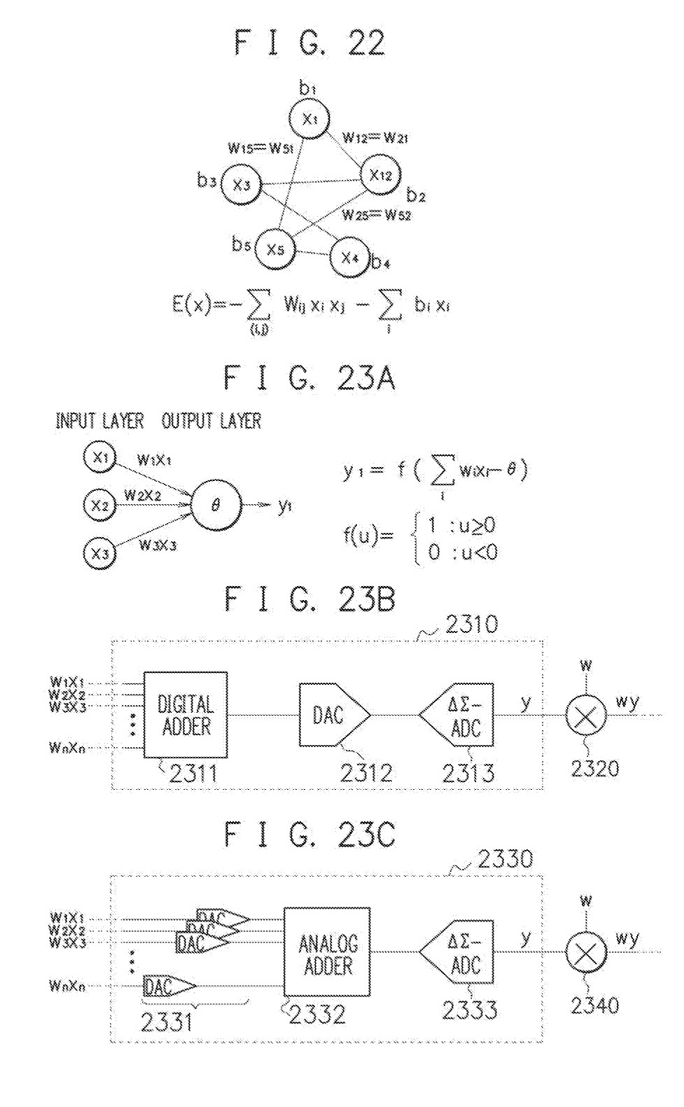

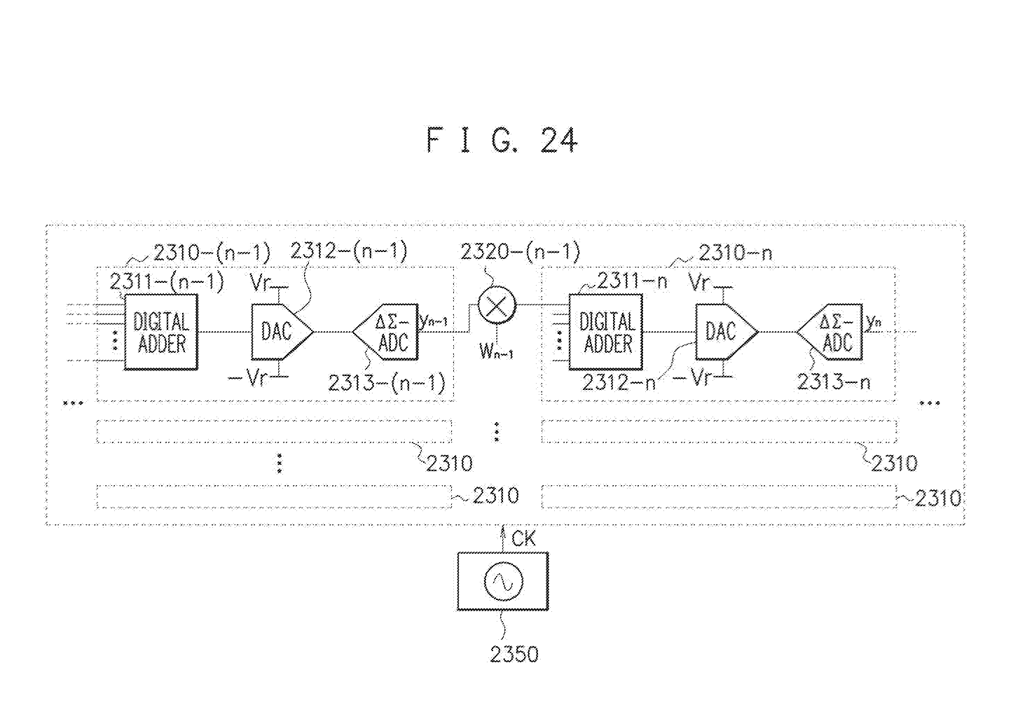

Such a control of the value of the temperature parameter and the operating frequency controls the frequency of the clock signal CK outputted from the variable frequency oscillator 1430 to increase an operating frequency 2002 every time a value 2001 of the temperature parameter is decreased as illustrated in FIG. 20. This ensures that the operating frequency is decreased to suppress the power consumption at high temperature where low accuracy is allowable, and the operating frequency is increased to reduce the quantization noise in a frequency band of the input signal by noise shaping to obtain high accuracy at low temperature where high accuracy is required.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

In an aspect of the embodiments, it is possible to control the operating frequency according to the required accuracy, thereby reducing the power consumption in the whole apparatus while keeping high accuracy.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A neural network apparatus comprising:
a plurality of neuron units each including:
an adder that performs addition processing relating to a plurality of weighted inputs;
one or more digital analog converters that perform digital-analog conversion processing relating to the plurality of weighted inputs; and
a delta-sigma analog digital converter that converts an analog signal indicating an added value obtained by adding all of the plurality of weighted inputs obtained from the adder and the one or more digital analog converters, into a pulse signal according to an amplitude of the analog signal, and outputs the pulse signal;
a plurality of arithmetic units each of which multiplies the pulse signal outputted from one of the plurality of neuron units by a weighted value, and outputs a result as the weighted input to another of the plurality of neuron units different from the one neuron unit;
an oscillator that is capable of changing a frequency of a clock signal to be outputted and supplies the clock signal to the neuron unit and the arithmetic unit; and
a control unit that controls the frequency of the clock signal to be outputted from the oscillator.

2. The neural network apparatus according to claim 1,
wherein a neuron unit in an i-th layer and a neuron unit in an (i+1)-th layer next to the i-th layer of the plurality of neuron units are connected via the arithmetic unit in the i-th layer, i being an arbitrary natural number.

3. The neural network apparatus according to claim 2, comprising the oscillator for each layer.

4. The neural network apparatus according to claim 1,
wherein the one neuron unit and the another neuron unit are connected to output bi-directionally the weighted input to each other.

5. The neural network apparatus according to claim 2,
wherein the control unit controls the frequency of the clock signal to be outputted from the oscillator, according to an accuracy rate after a certain number of times of learning is iterated by the neuron unit and the arithmetic unit.

6. The neural network apparatus according to claim 5,
wherein when the accuracy rate after the certain number of times of learning is iterated is equal to or lower than an accuracy rate at a previous time, the control unit increases the frequency of the clock signal to be outputted from the oscillator.

7. The neural network apparatus according to claim 2,
wherein the control unit increases the frequency of the clock signal to be outputted from the oscillator after a certain number of times of learning is iterated by the neuron unit and the arithmetic unit.

8. The neural network apparatus according to claim 2,
wherein the control unit controls the frequency of the clock signal to be outputted from the oscillator, according to a learning rate set in the neuron unit and the arithmetic unit.

9. The neural network apparatus according to claim 4,
wherein the control unit controls the frequency of the clock signal to be outputted from the oscillator, according to a temperature parameter.

10. The neural network apparatus according to claim 9,
wherein the control unit decreases the frequency of the clock signal to be outputted from the oscillator every time the temperature parameter is decreased.

11. The neural network apparatus according to claim 1,
wherein the adder is a digital adder that adds all of the plurality of weighted inputs, and
wherein a digital analog converter in each of the plurality of neuron units digital-analog converts an output from the digital adder and outputs a result to the delta-sigma analog digital converter.

12. The neural network apparatus according to claim 1,
wherein a plurality of digital analog converters in each of the plurality of neuron units digital-analog convert each of the plurality of the weighted inputs, and
wherein the adder is an analog adder that adds all of analog signals outputted from the plurality digital analog converters, and outputs a result to the delta-sigma analog digital converter.

13. A control method of a neural network apparatus, comprising:
by each of a plurality of neuron units,
performing addition processing relating to a plurality of weighted inputs, performing digital-analog conversion processing relating to the plurality of weighted inputs, and converting an analog signal indicating an added value obtained by adding all of the plurality of weighted inputs into a pulse signal according to an amplitude of the analog signal by a delta-sigma analog digital converter;
multiplying the pulse signal outputted from one of the plurality of neuron units by a weighted value, and outputting a result as the weighted input to another of the plurality of neuron units different from the one neuron unit;
controlling a frequency of a clock signal supplied to the neuron unit and the arithmetic unit by an oscillator capable of changing a frequency of a clock signal to be outputted, according to an accuracy of the neuron unit.
